(19) United States
(12) Patent Application Publication
(10) Pub. No.: US 2024/0029002 A1
(43) Pub. Date: Jan. 25, 2024

(54) METHOD AND SYSTEM FOR IDENTIFYING ANOMALIES IN COMPENSATION DATA

(71) Applicant: Dell Products L.P., Round Rock, TX (US)

(72) Inventors: Saurabh Jha, Bangalore (IN); Sailendu Kumar Patra, Bangalore (IN); Guhesh Swaminathan, Chennai (IN)

(21) Appl. No.: 17/871,534

(22) Filed: Jul. 22, 2022

(51) Int. Cl. G06Q 10/06; G06K 9/62

(52) U.S. Cl. CPC G06Q 10/06393; G06K 9/6298; G06K 9/6228

(57) ABSTRACT

Techniques described herein relate to a method for identifying anomalies in compensation data. The method includes identifying a compensation data anomaly detection event; in response to identifying the compensation data anomaly detection event: obtaining compensation data associated with the compensation data anomaly detection event; performing preprocessing on the compensation data to generate updated compensation data; performing feature grouping on the updated compensation data to generate grouped compensation data; performing change discovery using the grouped compensation data to identify potential anomalies; generating a comparative anomaly prediction using the potential anomalies; and performing anomaly remediation actions based on the comparative anomaly prediction.

### BACKGROUND

Organizations may include sales representatives that sell products, services or both. To incentivize and reward sales representatives, the organization may compensate sales representatives based on sales performance for a given period of time. It may be imperative to both the sales representatives and the organizations that the compensations awarded to the sales representatives are appropriate based on the sales performances of the sales representatives.

### SUMMARY

In general, certain embodiments described herein relate to a method for identifying anomalies in compensation data. The method may include identifying a compensation data anomaly detection event; in response to identifying the compensation data anomaly detection event: obtaining compensation data associated with the compensation data anomaly detection event; performing preprocessing on the compensation data to generate updated compensation data; performing feature grouping on the updated compensation data to generate grouped compensation data; performing change discovery using the grouped compensation data to identify potential anomalies; generating a comparative anomaly prediction using the potential anomalies; and performing anomaly remediation actions based on the comparative anomaly prediction.

In general, certain embodiments described herein relate to a system for identifying anomalies in compensation data. The system includes clients and an anomaly detection engine. The anomaly detection engine is configured to identify a compensation data anomaly detection event associated with compensation data of a client of the plurality of clients; in response to identifying the compensation data anomaly detection event: obtain compensation data associated with the compensation data anomaly detection event; perform preprocessing on the compensation data to generate updated compensation data; perform feature grouping on the updated compensation data to generate grouped compensation data; perform change discovery using the grouped compensation data to identify potential anomalies; generate a comparative anomaly prediction using the potential anomalies; and perform anomaly remediation actions based on the comparative anomaly prediction.

In general, certain embodiments described herein relate to a non-transitory computer readable medium that includes computer readable program code, which when executed by a computer processor enables the computer processor to perform a method for identifying anomalies in compensation data. The method may include identifying a compensation data anomaly detection event; in response to identifying the compensation data anomaly detection event: obtaining compensation data associated with the compensation data anomaly detection event; performing preprocessing on the compensation data to generate updated compensation data; performing feature grouping on the updated compensation data to generate grouped compensation data; performing change discovery using the grouped compensation data to identify potential anomalies; generating a comparative anomaly prediction using the potential anomalies; and performing anomaly remediation actions based on the comparative anomaly prediction.

Other aspects of the embodiments disclosed herein will be apparent from the following description and the appended claims.

### BRIEF DESCRIPTION OF DRAWINGS

Certain embodiments disclosed herein will be described with reference to the accompanying drawings. However, the accompanying drawings illustrate only certain aspects or implementations of the embodiments disclosed herein by way of example and are not meant to limit the scope of the claims.

FIG. 1A shows a diagram of a system in accordance with one or more embodiments disclosed herein.

FIG. 1B shows a diagram of an anomaly detection engine in accordance with one or more embodiments disclosed herein.

FIGS. 2A-2C show flowcharts of methods in accordance with one or more embodiments disclosed herein.

FIG. 3 shows a diagram of an example system over time in accordance with one or more embodiments disclosed herein.

FIG. 4 shows a diagram of a computing device in accordance with one or more embodiments disclosed herein.

### DETAILED DESCRIPTION

Specific embodiments will now be described with reference to the accompanying figures. In the following description, numerous details are set forth as examples of the embodiments disclosed herein. It will be understood by those skilled in the art that one or more embodiments of the present embodiments disclosed herein may be practiced without these specific details and that numerous variations or modifications may be possible without departing from the scope of the embodiments disclosed herein. Certain details known to those of ordinary skill in the art are omitted to avoid obscuring the description.

In the following description of the figures, any component described with regard to a figure, in various embodiments, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments disclosed herein relate to systems, non-transitory computer readable mediums, and methods for performing anomaly detection services to detect anomalies in compensation data.

In one or more embodiments, organizations may include sales representatives that sell products and/or services. To incentivize and/or reward the sales representatives, the organizations may financially compensate the sales representatives based on sales performances. Other employees (e.g., human resource workers, sales managers, etc.) of the organizations may manually review the sales performances of the sales representatives and determine, using one or more calculations based on the sales performances, the compensation to provide the sales representatives. For organizations with a significant quantity of sales representatives, such manual determinations of compensation for sales representatives may be susceptible to human error. Additionally, due to the importance of the compensation of the sales representatives to the organizations and the sales representatives, compensation data (e.g., sales performances and the associated financial compensations) associated with sales representatives may be manually reviewed to identify errors. For organizations with a significant quantity of sales representatives, such manual review of compensation data may also be susceptible to human error and may require a significant amount of user time.

To address, at least in part, the aforementioned sales representative compensation issues, embodiments disclosed herein provide anomaly detection services to identify anomalies in compensation data which may be associated with errors in financial compensation to sales representatives. Specifically, a system in accordance with embodiments disclosed herein may obtain, standardize, and transform compensation data associated with sales representatives to improve overall anomaly detection performance. The compensation data may further be grouped based on grouping criteria so that each group may include compensation data associated with similar sales representatives to improve anomaly detection accuracy and reduce false positives. Change discovery may then be performed on the grouped compensation data to identify potential anomalies and filter out compensation data not associated with the potential anomalies, reducing the quantity of compensation data required to perform anomaly detection and thereby improving the efficiency of anomaly detection system. The potential anomalies and the associated compensation data may be input into two different anomaly detection algorithms, which each generate anomaly predictions. A comparative anomaly prediction may be generated that includes anomalies detected by both anomaly detection algorithms, reducing false positives and improving the accuracy of the anomaly detection system.

Embodiments disclosed herein significantly reduce the user time required to review compensation data for errors by automatically providing the users with anomalous compensation data without requiring users to sift through large quantities of compensation data to check for errors. The accuracy of reviewing compensation data may be improved as human errors may be reduced. Furthermore, the impact of incorrect compensation data may also be reduced.

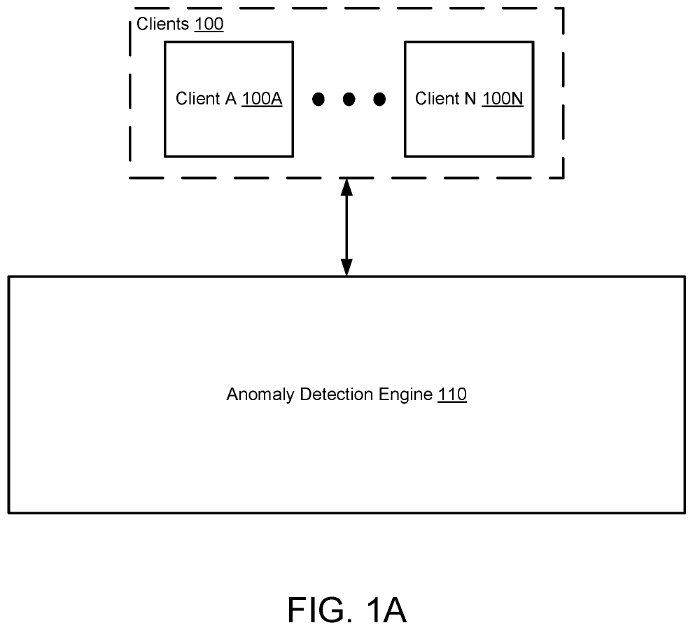

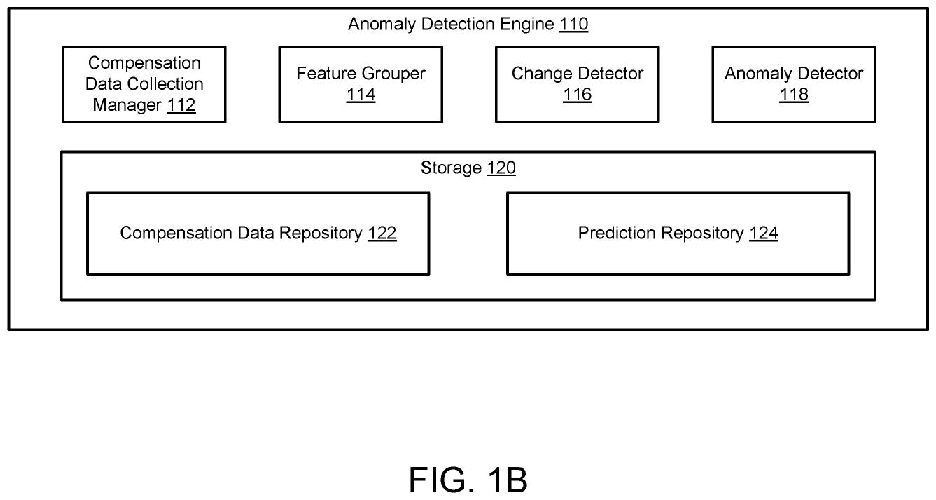

FIG. 1A shows a diagram of a system in accordance with one or more embodiments disclosed herein. The system may include clients (100) that obtain anomaly detection services from an anomaly detection engine (110). The anomaly detection services may include identifying anomalies in compensation data obtained from the clients (100) in order to prevent errors in the compensation of employees associated with the clients (100).

The components of the system illustrated in FIG. 1A may be operably connected to each other and/or operably connected to other entities (not shown) via any combination of wired and/or wireless networks. Each component of the system illustrated in FIG. 1A is discussed below.

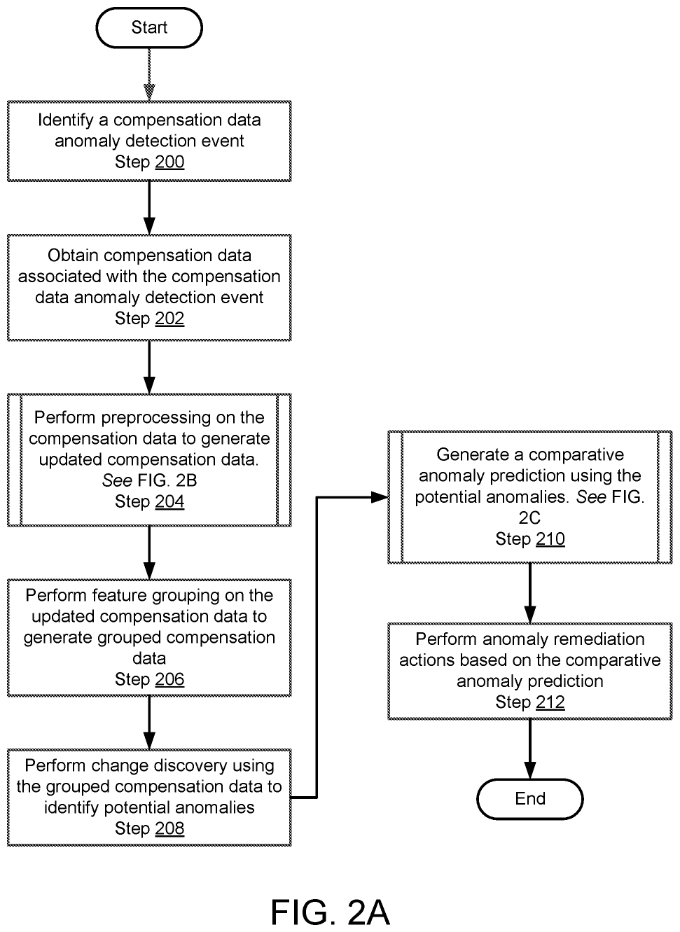

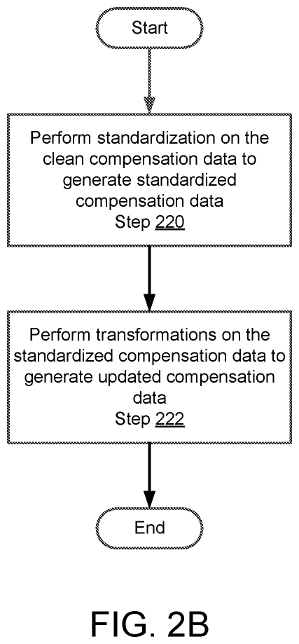

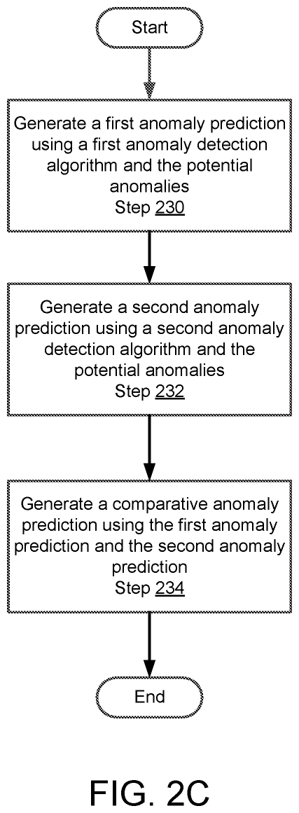

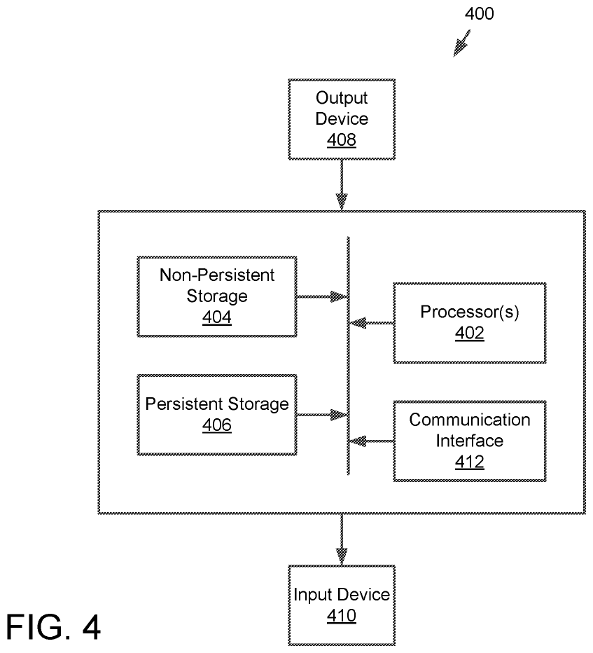

The clients (100) may be implemented using computing devices. The computing devices may be, for example, mobile phones, tablet computers, laptop computers, desktop computers, servers, or cloud resources. The computing devices may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions described herein and/or all, or a portion, of the methods illustrated in FIGS. 2A-2C. The clients (100) may be implemented using other types of computing devices without departing from embodiments disclosed herein. For additional details regarding computing devices, refer to FIG. 4.

The clients (100) may be implemented using logical devices without departing from embodiments disclosed herein. For example, the clients (100) may include virtual machines that utilize computing resources of any number of physical computing devices to provide the functionality of the clients (100). The clients (100) may be implemented using other types of logical devices without departing from the embodiments disclosed herein.

In one or more embodiments, the clients (100) include the functionality to and/or are otherwise configured to obtain anomaly detection services from the anomaly detection engine (110). Therefore, the clients (100) may include the functionality to provide generate, maintain, and provide compensation data to the anomaly detection engine (110) for anomaly detection services. Otherwise, users of the clients (100) may be required to manually compensation data for errors, which with large quantities compensation data, may require a significant amount of manual time and may be susceptible to human error. Using the anomaly detection services may enable the clients (100) to avoid inefficient use of computing and/or manual resources to perform anomaly detection to identify errors in compensation data associated with the clients (100). The clients (100) may include other and/or additional functionalities without departing from embodiments disclosed herein.

To use the anomaly detection services, the clients (100) may perform actions under the directions of the anomaly detection engine (110). By doing so, the anomaly detection engine (110) may orchestrate the transmission of data (e.g., compensation data) and/or actions between the anomaly detection engine (110) and the clients (100).

For example, a client (100) may send compensation data to the anomaly detection engine (110). The anomaly detection engine (110) may generate anomaly predictions that may specify anomalies in the compensation data. The anomaly detection engine (110) may then initiate the performance of anomaly remediation actions by the anomaly detection engine (110), the clients (100), and/or users of the clients (100) or anomaly detection engine (110).

A system in accordance with one or more embodiments disclosed herein may include any number of clients (e.g., 100A, 100N) without departing from embodiments disclosed herein. For example, a system may include a single client (e.g., client A (100A)) or multiple clients (e.g., client A (100A) and client N (100N)).

In one or more embodiments, the anomaly detection engine (110) may be implemented using one or more computing devices. A computing device may be, for example, a mobile phone, tablet computer, laptop computer, desktop computer, server, distributed computing system, or a cloud resource. The computing device may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions of the anomaly detection engine (110) described herein and/or all, or a portion, of the methods illustrated in FIGS. 2A-2C. The anomaly detection engine (110) may be implemented using other types of computing devices without departing from the embodiments disclosed herein. For additional details regarding computing devices, refer to FIG. 4.

The anomaly detection engine (110) may be implemented using logical devices without departing from the embodiments disclosed herein. For example, the anomaly detection engine (110) may include virtual machines that utilize computing resources of any number of physical computing devices to provide the functionality of the anomaly detection engine (110). The anomaly detection engine (110) may be implemented using other types of logical devices without departing from the embodiments disclosed herein.

In one or more embodiments, the anomaly detection engine (110) may include the functionality to, or otherwise be configured to, perform detection services. The anomaly detection services may include generating anomaly detection predictions associated with compensation data obtained from the clients (100). By doing so, the anomaly detection engine (110) may improve the efficiency and accuracy of identifying errors in compensation data, thereby reducing the negative impact associated with such errors. The anomaly detection engine (110) may include the functionality to perform other and/or additional services without departing from embodiments disclosed herein. For additional information regarding the functionality of the anomaly detection engine (110), refer to FIGS. 2A-2C. For additional information regarding the components of the anomaly detection engine (110), refer to FIG. 1B.

Although the system of FIG. 1A is shown as having a certain number of components (e.g., 100, 100A, 100B, 110), in other embodiments disclosed herein, the system may have more or fewer components. For example, the functionality of each component described above may be split across components or combined into a single component (e.g., the functionalities of the anomaly detection engine (110) and a client may be combined to be implemented by a single component). Further still, each component may be utilized multiple times to carry out an iterative operation.

FIG. 1B shows a diagram of an anomaly detection engine in accordance with one or more embodiments disclosed herein. The anomaly detection engine (110) may be an embodiment of the anomaly detection engine (110, FIG. 1A) discussed above. As discussed above, the anomaly detection engine (110) may include the functionality to perform anomaly detections services on compensation data obtained from clients (100). To perform the anomaly detection services, the anomaly detection engine may include a compensation data collection manager (112), a feature grouper (114), a change detector (116), an anomaly detector (118), and a storage (120). The anomaly detection engine (110) may include other, additional, and/or fewer components without departing from embodiments disclosed herein. Each of the aforementioned components of the anomaly detection engine (110) is discussed below.

In one or more embodiments disclosed herein, the compensation data collection manager (112) is implemented as physical device. The physical device may include circuitry. The physical device may be, for example, a field-programmable gate array, application specific integrated circuit, programmable processor, microcontroller, digital signal processor, or other hardware processor. The physical device may be configured to provide the functionality of the compensation data collection manager (112) described throughout this Detailed Description.

In one or more embodiments disclosed herein, the compensation data collection manager (112) is implemented as computer instructions, e.g., computer code, stored on a persistent storage that when executed by a processor of the anomaly detection engine (110) causes the anomaly detection engine (110) to provide the functionality of the compensation data collection manager (112) described throughout this Detailed Description.

In one or more embodiments, the compensation data collection manager (112) includes the functionality to, or is otherwise configured to, obtain and manage compensation data. The compensation data collection manager (112) may request for and/or obtain compensation data from the clients (100) and/or other entities not illustrated in the system of FIG. 1A (e.g., third party entities, users, etc.). The compensation data collection manager (112) may include the functionality to store the compensation data in the storage (120) (e.g., in the compensation repository (122), discussed below). The compensation data collection manager (112) may further include the functionality to provide compensation data to other components of the anomaly detection engine (110) (e.g. the feature grouper (114), the change detector (116), and/or the anomaly detector (118)). The compensation data collection manager (112) may include the functionality to perform all, or a portion thereof, the steps in the methods depicted in FIGS. 2A-2C. The compensation data collection manager (112) may include, or be configured to perform, other and/or additional functionalities without departing from embodiments disclosed herein. For additional information regarding the functionality of the compensation data collection manager (112), refer to FIGS. 2A-2C.

In one or more embodiments disclosed herein, the feature grouper (114) is implemented as physical device. The physical device may include circuitry. The physical device may be, for example, a field-programmable gate array, application specific integrated circuit, programmable processor, microcontroller, digital signal processor, or other hardware processor. The physical device may be configured to provide the functionality of the feature grouper (114) described throughout this Detailed Description.

In one or more embodiments disclosed herein, the feature grouper (114) is implemented as computer instructions, e.g., computer code, stored on a persistent storage that when executed by a processor of the anomaly detection engine (110) causes the anomaly detection engine (110) to provide the functionality of the feature grouper (114) described throughout this Detailed Description.

In one or more embodiments, the feature grouper (114) includes the functionality to, or is otherwise configured to, perform feature grouping on compensation data to generate grouped compensation data. The feature grouper (114) may include the functionality to perform all, or a portion thereof, the steps in the methods depicted in FIGS. 2A-2C. The feature grouper (114) may include or be configured to perform other and/or additional functionalities without departing from embodiments disclosed herein. For additional information regarding the functionality of the feature grouper (114), refer to FIGS. 2A-2C.

In one or more embodiments disclosed herein, the change detector (116) is implemented as physical device. The physical device may include circuitry. The physical device may be, for example, a field-programmable gate array, application specific integrated circuit, programmable processor, microcontroller, digital signal processor, or other hardware processor. The physical device may be configured to provide the functionality of the change detector (116) described throughout this Detailed Description.

In one or more embodiments disclosed herein, the change detector (116) is implemented as computer instructions, e.g., computer code, stored on a persistent storage that when executed by a processor of the anomaly detection engine (110) causes the anomaly detection engine (110) to provide the functionality of the change detector (116) described throughout this Detailed Description.

In one or more embodiments, the change detector (116) includes the functionality to, or is otherwise configured to, identify significant changes in the compensation data that may be labeled as potential anomalies using the grouped compensation data generated by the feature grouper (114). The change detector (116) may include the functionality to perform all, or a portion thereof, the steps in the methods depicted in FIGS. 2A-2C. The change detector (116) may include or be configured to perform other and/or additional functionalities without departing from embodiments disclosed herein. For additional information regarding the functionality of the change detector (116), refer to FIGS. 2A-2C.

In one or more embodiments disclosed herein, the anomaly detector (118) is implemented as physical device. The physical device may include circuitry. The physical device may be, for example, a field-programmable gate array, application specific integrated circuit, programmable processor, microcontroller, digital signal processor, or other hardware processor. The physical device may be configured to provide the functionality of the anomaly detector (118) described throughout this Detailed Description.

In one or more embodiments disclosed herein, the anomaly detector (118) is implemented as computer instructions, e.g., computer code, stored on a persistent storage that when executed by a processor of the anomaly detection engine (110) causes the anomaly detection engine (110) to provide the functionality of the anomaly detector (118) described throughout this Detailed Description.

In one or more embodiments, the anomaly detector (118) includes the functionality to, or is otherwise configured to, detect anomalies in compensation data by generating anomaly predictions using potential anomalies identified by the change detector (116). The anomaly detector (118) may include the functionality to perform all, or a portion thereof, the steps in the methods depicted in FIGS. 2A-2C. The anomaly detector (118) may include or be configured to perform other and/or additional functionalities without departing from embodiments disclosed herein. For additional information regarding the functionality of the anomaly detector (118), refer to FIGS. 2A-2C.

In one or more embodiments, the storage (120) may be implemented using one or more volatile or non-volatile storages or any combination thereof. The storage (120) may include the functionality to, or otherwise be configured to, store information that may be used by the anomaly detection engine (110) and the components thereof (e.g., 112, 114, 116, 118) to perform anomaly detection services on compensation data of clients (100). The information stored in the storage (120) may include a compensation data repository (122) and a prediction repository (124). The storage (120) may store other and/or additional information without departing from embodiments disclosed herein. Each of the aforementioned types of information stored in the storage (120) is discussed below.

In one or more embodiments, the compensation data repository (122) may include one or more data structures that include compensation data. The compensation data may include sales data and financial compensation data associated with sales representatives of an organization associated with one or more clients (100). The compensation data may include compensation data parameters. The compensation data parameters may include sales quota, sales volume, sales attainment, sales modifiers, and sales bonuses. The compensation data may include other and/or additional compensation parameters without departing from embodiments disclosed herein. A sales quota may refer to sales target (e.g., the number of products sold or the total amount of money earned through sales) for a given period of time. The sales volume may refer to the total revenue achieved for a given period. The sales attainment may refer to the percentage of the sales quota obtained for a given period. The sales modifiers may refer to the added financial benefits (e.g., bonuses) provided to sales representatives for selling products. The sales bonuses may refer to the amount of financial compensation provided to a sales representative for achieving the sales quota. The anomaly detection engine (110) may detect anomalies associated with one or more of the aforementioned compensation data parameters.

The compensation data repository (122) may also include compensation metadata associated with the compensation data. The compensation metadata may include information associated with each sales representative and their corresponding compensation data. The compensation metadata may include, but not be limited to, a sales representative identifier, a geographical region associated with the sales representative, a strategic business unit (e.g., merchandise, technology, apparel, etc.) associated with the sales representative, an human resources plan associated with the sales representative (e.g., salaried employee, contract employee, etc.), a sales role (e.g., entry level representative, primary sales representative, managing sales representative, etc.) associated with the sales representative, a credit type associated with the sales representative (e.g., salary, bonus types, modifier types, etc.), a compensation update timestamp (e.g., date and time), and a time period associated with the corresponding compensation data (e.g., month, past thirty days, etc.). The compensation metadata may include other and/or additional information associated with the sales representative and/or the compensation data without departing from embodiments disclosed herein.

The aforementioned compensation data and compensation metadata may be continuous in nature over a given period of time. In other words, the compensation data and compensation metadata may include compensation data corresponding to multiple, hours, days, weeks, months, etc. within a given time period (e.g., week, month, year, past thirty days, etc.). For example, the compensation data may include compensation data parameters updates (e.g., sales volume) for every day for the past thirty days. The clients (100) or other entities (e.g., third party entities not shown in the system of FIG. 1A) may stream, or otherwise provide, the compensation data and compensation metadata at multiple points for a given time period. For example, a client (e.g., 100A) may stream the sales volume every day for a month.

In one or more embodiments, the compensation data collection manager (112) may include the functionality to maintain the compensation data repository (122). As discussed above, the compensation data collection manager (112) may request and/or obtain compensation data and compensation metadata, and store the compensation data and compensation metadata in the compensation data repository (122). The compensation data collection manager (112) may provide compensation data and compensation metadata from the compensation data repository (122) to the feature grouper (114) for the performance of anomaly detection services. The compensation data collection manager (112) may perform other and/or additional maintenance actions (e.g., removing compensation data and compensation metadata, copying compensation data and compensation metadata, providing compensation data and compensation metadata to clients (100), etc.) associated with the compensation data repository (122) without departing from embodiments disclosed herein.

In one or more embodiments, the prediction repository (124) may include one or more data structures that include anomaly detection predictions and information associated with the anomaly detection predictions. The anomaly detection predictions may include one or more compensation data parameters that are identified as anomalous or outliers compared to other compensation data parameters. The anomaly detection prediction may include, for example, a sales representative identifier associated with one or more compensation data parameters that are identified as anomalous. Such anomalous compensation data parameters may include, or otherwise be associated with, errors in compensation data (e.g., entry errors, improper financial compensation to sales representatives, etc.). The prediction repository (124) may further include information generated during the performance of anomaly detection services. Such information may include, groups of compensation data generated by the feature grouper (114), potential anomalies identified by the change detector (116), and/or anomaly predictions and comparative anomaly predictions generated by the anomaly detector (118) (all discussed below in FIGS. 2A-2C). The prediction repository (124) may include other and/or additional information without departing from embodiments disclosed herein.

While the data structures (e.g., 122, 124) are illustrated as separate data structures and have been discussed as including a limited amount of specific information, any of the aforementioned data structures may be divided into any number of data structures, combined with any number of other data structures, and may include additional, less, and/or different information without departing from embodiments disclosed herein. Additionally, while illustrated as being stored in the storage (120), any of the aforementioned data structures may be stored in different locations (e.g., in storage of other computing devices) and/or spanned across any number of computing devices without departing from embodiments disclosed herein.

FIGS. 2A-2C show flowcharts of methods in accordance with one or more embodiments disclosed herein. Turning now to FIG. 2A, FIG. 2A shows a flowchart of a method performed detect anomalies in compensation data in accordance with one or more embodiments disclosed herein. The method shown in FIG. 2A may be performed, for example, by a combination of the compensation data collection manager (e.g., 112 FIG. 1B), the feature grouper (e.g., 114, FIG. 1B), the change detector (e.g., 116, FIG. 1B), and the anomaly detector (e.g., 118, FIG. 1B). Other components of the system in FIGS. 1A-1B may perform all, or a portion, of the method of FIG. 2A without departing from the scope of the embodiments described herein.

While FIG. 2A is illustrated as a series of steps, any of the steps may be omitted, performed in a different order, additional steps may be included, and/or any or all of the steps may be performed in a parallel and/or partially overlapping manner without departing from the scope of the embodiments described herein.

Initially, in Step 200, a compensation data anomaly detection event is identified. In one or more embodiments, the compensation data collection manager may identify the compensation data anomaly detection event. The compensation data anomaly detection event may include obtaining a compensation data anomaly detection request from a client or a user of the client, the occurrence of a point in time specified by a compensation data anomaly detection schedule, obtaining a sufficient amount of compensation data to perform anomaly detection, etc. The compensation data collection manager may monitor a compensation data anomaly detection schedule and identify points in time specified by the compensation data anomaly detection schedule. The compensation data collection manager may monitor the quantity of compensation data obtained for a given period and may identify when the period is up or when sufficient compensation data is obtained to perform anomaly detection. The compensation data anomaly detection event may be identified via other and/or additional methods without departing from embodiments disclosed herein.

In Step 202, compensation data associated with the compensation data anomaly detection event is obtained. In one or more embodiments, the document collection manager of the document preprocessing engine may first check the compensation data repository for previously obtained compensation data (e.g., compensation data streamed, or otherwise provided, to the compensation data collection manager prior to identifying the compensation data anomaly detection event). The compensation data collection manager may, if present, retrieve the compensation data from the compensation data repository of the storage of the anomaly detection engine. In one or more embodiments, the compensation data anomaly detection event may be associated with a portion of the compensation data stored in the compensation data repository (e.g., only compensation data associated with a given period of time, only compensation data associated with particular sales representatives, etc.). In such embodiments, the compensation data collection manager may obtain a portion of the compensation data associated with the compensation detection event using the compensation metadata (e.g., compensation data timestamps, sales representative identifiers, etc.). The compensation data collection manager may also obtain the compensation metadata corresponding to the compensation data associated with the compensation data anomaly detection event.

In one or more embodiments, if there are no, or an insufficient quantity of, compensation data included in the compensation data repository, then the compensation data collection manager may send a message that includes a request for compensation data to one or more clients. In response to obtaining the request, the one or more clients may generate and/or retrieve the compensation data and send the compensation data to the compensation data collection manager. In one or more embodiments, the document collection manager may send a message to the third party entity. The message may include a request for the compensation data. In response to obtaining the request, the third party entity may generate and/or retrieve the compensation data and send the compensation data to the compensation data collection manager.

The compensation data collection manager may also obtain the compensation metadata corresponding to the compensation data associated with the compensation data anomaly detection event using the methods described above. The compensation data associated with the compensation data anomaly detection event may be obtained via other and/or additional methods without departing from embodiments disclosed herein.

In Step 204, preprocessing is performed on the compensation data to generate updated compensation. In one or more embodiments, the compensation data collection manager performs preprocessing on the compensation data associated with the compensation data anomaly detection event to generate the updated compensation data. Preprocessing may be performed on the compensation data to generate updated compensation data via other and/or additional methods without departing from embodiments disclosed herein. For additional information regarding preforming preprocessing on the compensation data to generate updated compensation, refer to FIG. 2B.

In Step 206, feature grouping is performed on the updated compensation data to generate grouped compensation data. In one or more embodiments, the compensation data collection manager may provide the updated compensation data. In one or more embodiments, the feature grouper groups the updated compensation data using one or more grouping criteria specified by the compensation metadata. For example, the feature grouper may group compensation data based one or more grouping criteria including, but not limited to, geographical region, strategic business unit, products, human resources plan, role, credit type, and given time period associated with the compensation data. Compensation data with the same, or similar, grouping criteria may be placed in the same group by the feature grouper. As a result, the change detector and anomaly detector may only compare compensation data within the same group (e.g., similar compensation data) to reduce false positives in anomaly detection and to increase the overall accuracy of the anomaly detection services. The grouped compensation data may include any number of groups of similar compensation data without departing from embodiments disclosed herein. The feature grouper may use any appropriate methods for grouping similar compensation data based on grouping criteria without departing from embodiments disclosed herein. For example, a K-means clustering algorithm may be used to grouping similar compensation data based on grouping criteria. Feature grouping may be performed on the updated compensation data to generate grouped compensation data via other and/or additional methods without departing from embodiments disclosed herein.

In Step 208, change discovery is performed on the grouped compensation data to identify potential anomalies. In one or more embodiments, the feature grouper provides the grouped compensation data to the change detector. In one or more embodiments, the change detector performs the change discovery on the grouped compensation data to identify potential anomalies. The change detector inputs each group of the grouped compensation data to a change detection algorithm that identifies compensation data that includes significant changes in the compensation data associated with the group. The change detector may include an online change point detection algorithm that implements a maximum mean discrepancy technique to compare the distance between distributions of recent samples of compensation data with distributions of older samples of compensation data using exponential moving averages. Compensation data associated with distribution distances above a threshold may be identified as potential anomalies by the change detector. The change detector may use other and/or additional change detection algorithms to identify potential anomalies in grouped compensation data without departing from embodiments disclosed herein. Change discovery may be performed on the grouped compensation data to identify potential anomalies via other and/or additional methods without departing from embodiments disclosed herein.

In Step 210, a comparative anomaly prediction is generated using the potential anomalies. In one or more embodiments, the change detector provides the potential anomalies and the grouped compensation data associated with the potential anomalies to the anomaly detector. The anomaly detector then uses the compensation data to generate a comparative anomaly prediction associated with the potential anomalies. A comparative anomaly prediction may be generated using the potential anomalies via other and/or additional methods without departing from embodiments disclosed herein. For additional information regarding generating a comparative anomaly prediction using the potential anomalies, refer to FIG. 2C.

In Step 212, anomaly remediation actions are performed based on the comparative anomaly prediction. In one or more embodiments, the anomaly detector performs the one or more anomaly remediation actions based on the comparative anomaly prediction. In one or more embodiments, the anomaly detector may perform different remediation actions depending on if the comparative anomaly prediction indicates that an anomaly has been detector or not. For example, if the comparative anomaly prediction indicates that an anomaly has been detected, the anomaly detector may perform one or more anomaly remediation actions from a first set of anomaly remediation actions (e.g., notify the client or a user of a client associated with the comparative data that an anomaly is detected, provide comparative data and comparative metadata associated with the comparative anomaly prediction, etc.). If the comparative anomaly prediction indicates that an anomaly has not been detected, the anomaly detector may perform one or more anomaly remediation actions from a second set of anomaly remediation actions (e.g., notify the client or a user of a client associated with the comparative data that no anomaly is detected, do nothing, wait for additional compensation data or another compensation data anomaly detection event, etc.). The anomaly remediation actions may include other and/or additional actions that may be performed based on the comparative anomaly prediction without departing from embodiments disclosed herein. Anomaly remediation actions may be performed based on the comparative anomaly prediction via other and/or additional methods without departing from embodiments disclosed herein.

In one or more embodiments disclosed herein, the method ends following Step 212.

Turning now to FIG. 2B, FIG. 2B shows a flowchart of a method for performing preprocessing on compensation data to generate updated compensation data in accordance with one or more embodiments disclosed herein. The method shown in FIG. 2B may be performed, for example, the compensation data collection manager (e.g., 112, FIG. 1B). Other components of the system in FIGS. 1A-1B may perform all, or a portion, of the method of FIG. 2B without departing from the scope of the embodiments described herein.

While FIG. 2B is illustrated as a series of steps, any of the steps may be omitted, performed in a different order, additional steps may be included, and/or any or all of the steps may be performed in a parallel and/or partially overlapping manner without departing from the scope of the embodiments described herein.

Initially, in Step 220, standardization is performed on the compensation data to generate standardized compensation data. In one or more embodiments, the compensation data may include non-continuous data and/or data associated with different points in time compared to other compensation data. To address this issue, the compensation data collection manager may generate dummy compensation data to fill in gaps of time between non-continuous data and to standardize the compensation data for a given period of time.

For example, in a scenario in which the compensation data includes sales volumes for the past thirty days, the sales volume compensation data associated with one sales representative may include a gap between the fifteenth day and the twentieth day of the thirty day time period. As a result, the compensation data collection manager may generate dummy compensation data that matches the sale volume value on the fifteenth day for each day in the gap between the fifteenth and the twentieth days. Therefore, the standardized compensation data includes sales volume values in each of the days between the fifteenth and twentieth days. As another example, in the scenario mentioned above, a second sales representative may include weekly sales volume values in the compensation data while all other sales representatives include daily sales volume values. To address the inconsistency, the compensation data collection manager may generate dummy compensation data values for the second sales representative such that each weekly sales volume value is copied for every day of the week so that the standardized compensation data includes daily sales volume values for the second sales representative.

Standardization may be performed on the compensation data to generate standardized compensation data via other and/or additional methods without departing from embodiments disclosed herein.

In Step 222, transformations are performed on the standardized compensation data to generate updated compensation data. In one or more embodiments, the compensation data collection manager performs transformations on the standardized compensation data by generating differential shift transformations and percent changes in the compensation data. The differential shift transformations may specify the changes between values of compensation data for a given sales representative. A differential shift transformation associated with a compensation data value may specify the previous compensation value and whether the change, if any, between the two was a positive change (e.g., the value increased from the previous value) or a negative change (e.g., the value decreased from the previous value). The percent changes may specify the percent change from a compensation data value and the previous compensation data value. The transformations result in additional features that may improve the performance of the change detector and the anomaly detector in accurately identifying anomalies in the compensation data. Other and/or additional transformation techniques may be performed on the standardized compensation data to generate updated conversation data without departing from embodiments disclosed herein.

In one or more embodiments disclosed herein, the method ends following Step 222.

Turning now to FIG. 2C, FIG. 2C shows a flowchart of a method for generating a comparative anomaly prediction in accordance with one or more embodiments disclosed herein. The method shown in FIG. 2C may be performed, for example, the anomaly detector (e.g., 118, FIG. 1B). Other components of the system in FIGS. 1A-1B may perform all, or a portion, of the method of FIG. 2C without departing from the scope of the embodiments described herein.

While FIG. 2C is illustrated as a series of steps, any of the steps may be omitted, performed in a different order, additional steps may be included, and/or any or all of the steps may be performed in a parallel and/or partially overlapping manner without departing from the scope of the embodiments described herein.

Initially, in Step 230, a first anomaly prediction is generated using a first anomaly detection algorithm and the potential anomalies. In one or more embodiments, the anomaly detector inputs the potential anomalies and associated grouped compensation data into a first anomaly detection algorithm to generate a first anomaly prediction. The first anomaly detection algorithm may be a Copula-based multivariate outlier detection algorithm. The first anomaly detection algorithm may include other and/or additional anomaly detection algorithms without departing from embodiments disclosed herein. The first anomaly prediction may specify whether the first anomaly detection algorithm identifies the potential anomalies as anomalies. The first anomaly prediction may include a list of sales representative identifiers associated with compensation data that include anomalies detected by the first anomaly detection algorithm. The first anomaly prediction may include other and/or additional information indicating anomalous compensation data detected by the first anomaly detection algorithm without departing from embodiments disclosed herein. The first anomaly prediction may be generated using a first anomaly detection algorithm and the potential anomalies via other and/or additional methods without departing from embodiments disclosed herein.

In Step 232, a second anomaly prediction is generated using a second anomaly detection algorithm and the potential anomalies. In one or more embodiments, the anomaly detector inputs the potential anomalies and associated grouped compensation data into a second anomaly detection algorithm to generate a second anomaly prediction. The second anomaly detection algorithm may be a kernel density estimation algorithm. The second anomaly detection algorithm may include other and/or additional anomaly detection algorithms without departing from embodiments disclosed herein. In one or more embodiments disclosed herein, the second anomaly detection algorithm is different than the first anomaly detection algorithm. The second anomaly prediction may specify whether the second anomaly detection algorithm identifies the potential anomalies as anomalies. The second anomaly prediction may include a list of sales representative identifiers associated with compensation data that include anomalies detected by the first anomaly detection algorithm. The second anomaly prediction may include other and/or additional information indicating anomalous compensation data detected by the second anomaly detection algorithm without departing from embodiments disclosed herein. The second anomaly prediction may be generated using a second anomaly detection algorithm and the potential anomalies via other and/or additional methods without departing from embodiments disclosed herein.

In Step 234, a comparative anomaly prediction is generated using the first anomaly prediction and the second anomaly prediction. In one or more embodiments, the anomaly detector generates a comparative anomaly prediction by comparing the first anomaly prediction with the second anomaly prediction. As discussed above, the first anomaly prediction may include a list of sales representative identifiers associated with compensation data that the first anomaly detection algorithm identifies as anomalous, and the second anomaly prediction may include a list of sales representative identifiers associated with compensation data that the second anomaly detection algorithm identifies as anomalous. The comparative anomaly prediction may include a list of sales representative identifiers associated with compensation data that was identified as anomalous by both the first anomaly detection algorithm and the second anomaly detection algorithm. The comparative anomaly prediction may include other and/or additional information indicating anomalous compensation data detected by both the first anomaly detection algorithm and the second anomaly detection algorithm without departing from embodiments disclosed herein. A comparative anomaly prediction may be generated using the first anomaly prediction and the second anomaly prediction via other and/or additional methods without departing from embodiments disclosed herein.

In one or more embodiments disclosed herein, the method ends following Step 234.

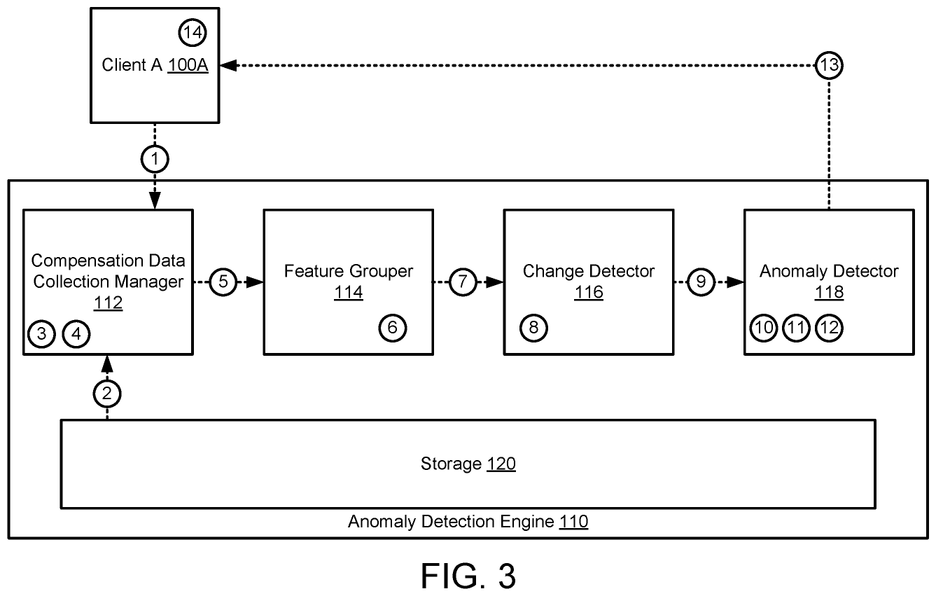

To further clarify aspects of embodiments disclosed herein, a non-limiting example is provided in FIG. 3. FIG. 3 shows a diagram of an example system and actions that may be performed by the example system over time. The example system of FIG. 3 may be similar to that of FIGS. 1A-1B. For the sake of brevity, only a limited number of components of the system of FIGS. 1A-1B are illustrated in FIG. 3.

### Example

FIG. 3 shows a diagram of an example in accordance with one or more embodiments disclosed herein. The example may include performing anomaly detection services on compensation data for a client.

Consider a scenario as illustrated in FIG. 3 in which an anomaly detection engine (110) is providing anomaly detection services for client A (100A). To perform the anomaly detection services, the anomaly detection engine (110) includes a compensation data collection manager (112), a feature grouper (114), a change detector (116), an anomaly detector (118), and storage (120). Client A (100A) is associated with an organization that includes sales representative that sell products. To reward sales representatives for selling products, the organization may compensate the sales representatives based on their sales performance. A user of client A (100A) generates compensation data associated with the sales representatives, which client A (100A) streams to the compensation data collection manager (112) of the anomaly detection engine (110) for anomaly detection services.

At a first point in time, client A (100A) sends an anomaly detection request to the compensation data collection manager (112) to perform anomaly detection services on compensation data of the sales representatives for the past thirty days [1]. In response to obtaining the anomaly detection request, the compensation data collection manager (112) obtains previously stored compensation data and compensation metadata from a compensation data repository (not shown in FIG. 3) of the storage (120) [2]. After obtaining the compensation data, the compensation data collection manager (112) then performs standardization on the compensation data to generate dummy compensation data values to ensure that the compensation data is continuous in nature (e.g., fill in gaps in the compensation data) [3]. The compensation data collection manager (112) then performs transformations on the standardized compensation data to generate differential shift transformations and percent changes associated with the compensation data to generate updated compensation data [4].

After generating the updated compensation data, the compensation data collection manager (112) then provides the updated compensation data to the feature grouper (114) [5]. In response to obtaining the updated compensation data, the feature grouper (114) performs grouping on the compensation data based on grouping criteria specified by the compensation metadata to generate compensation data groups [6]. Each group of the compensation data groups comprises compensation data associated with similar sales representatives to avoid false positives and improve the accuracy of anomaly detection.

After generating the grouped compensation data, the feature grouper (114) provides the grouped compensation data to the change detector (116) [7]. The change detector (116) then performs change discovery on each group of the grouped compensation data to identify significant changes in the grouped compensation data [8]. The change detector (116) identifies the compensation data associated with the significant changes as potential anomalies. The change detector (116) then provides the potential anomalies and the groups of compensation data associated with the potential anomalies to the anomaly detector (180) [9].

In response to obtaining the potential anomalies and associated grouped compensation data, the anomaly detector (118) generates a first anomaly prediction using the potential anomalies, the associated grouped compensation data, and a first anomaly detection algorithm [10]. The first anomaly prediction specifies that three sales representatives are associated with anomalous compensation data. After generating the first anomaly prediction, the anomaly detector (118) generates a second anomaly prediction using the potential anomalies, the associated grouped compensation data, and a second anomaly detection algorithm [11]. The first anomaly prediction specifies that two sales representatives are associated with anomalous compensation data. The anomaly detector (118) then generates a comparative anomaly prediction by comparing the first anomaly prediction and the second anomaly prediction [12]. Of the three sales representatives specified by the first anomaly prediction, only one of them is also specified by the second anomaly prediction. As a result, the comparative anomaly prediction specifies that the one sales representative specified by both the first anomaly prediction and the second anomaly prediction is anomalous.

Based on the comparative anomaly prediction, the anomaly detector (118) performs remediation actions including notifying the user of client A (100A) that the one sales representative is associated with anomalous compensation data and providing the compensation data associated with the one sales representative to client A (100A) [13]. The user of client A (100A) then addresses the anomalous compensation data associated with the one sales representative [14].

End of Example

Embodiments disclosed herein may be implemented using computing devices and/or computing systems. FIG. 4 shows a diagram of a computing device in accordance with one or more embodiments disclosed herein. Computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), communication interface (412) (e.g., Bluetooth interface, infrared interface, network interface, optical interface, etc.), input devices (410), output devices (408), and numerous other elements (not shown) and functionalities. Each of these components is described below.

In one embodiment disclosed herein, computer processor(s) (402) may be an integrated circuit for processing instructions. For example, the computer processor(s) may be one or more cores or micro-cores of a processor. Computing system (400) may also include one or more input devices (410), such as a touchscreen, keyboard, mouse, microphone, touchpad, electronic pen, or any other type of input device. Further, communication interface (412) may include an integrated circuit for connecting computing system (400) to a network (not shown) (e.g., a local area network (LAN), a wide area network (WAN) such as the Internet, mobile network, or any other type of network) and/or to another device, such as another computing system.

In one embodiment disclosed herein, computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to computer processor(s) (402), non-persistent storage (404), and persistent storage (406). Many different types of computing devices exist, and the aforementioned input and output device(s) may take other forms.

In one or more embodiments, any non-volatile storage (not shown) and/or memory (not shown) of a computing device or system of computing devices may be considered, in whole or in part, as non-transitory computer readable mediums, which may store software and/or firmware.

Such software and/or firmware may include instructions which, when executed by the one or more processors or other hardware (e.g., circuitry) of a computing device and/or system of computing devices, cause the one or more processors and/or other hardware components to perform operations in accordance with one or more embodiments described herein.

The software instructions may be in the form of computer readable program code to perform, when executed, methods of embodiments as described herein, and may, as an example, be stored, in whole or in part, temporarily or permanently, on a non-transitory computer readable medium such as a compact disc (CD), digital versatile disc (DVD), storage device, diskette, tape storage, flash storage, physical memory, or any other non-transitory computer readable medium. As discussed above, embodiments disclosed herein may be implemented using computing devices.

The problems discussed throughout this disclosure should be understood as being examples of problems solved by embodiments disclosed herein and the embodiments disclosed herein should not be limited to solving the same/similar problems. The disclosed embodiments are broadly applicable to address a range of problems beyond those discussed herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for identifying anomalies in compensation data, comprising:
identifying a compensation data anomaly detection event;
in response to identifying the compensation data anomaly detection event:
obtaining compensation data associated with the compensation data anomaly detection event;
performing preprocessing on the compensation data to generate updated compensation data;
performing feature grouping on the updated compensation data to generate grouped compensation data;
performing change discovery using the grouped compensation data to identify potential anomalies;
generating a comparative anomaly prediction using the potential anomalies; and
performing anomaly remediation actions based on the comparative anomaly prediction.

2. The method of claim 1, wherein performing preprocessing on the compensation data to generate the updated compensation data comprises:
performing standardization on the compensation data to generate standardized compensation data; and
performing transformations on the standardized compensation data to generate the updated compensation data.

3. The method of claim 1, wherein generating the comparative anomaly prediction using the potential anomalies comprises:
generating a first anomaly prediction using a first anomaly detection algorithm and the potential anomalies;
generating a second anomaly prediction using a second anomaly detection algorithm and the potential anomalies; and
generating the comparative anomaly prediction using the first anomaly prediction and the second anomaly prediction.

4. The method of claim 1, wherein the compensation data is associated with a period of time.

5. The method of claim 1, wherein the compensation data is associated with a plurality of users.

6. The method of claim 5, wherein the compensation data comprises:
compensation metadata associated with the plurality of users,
sales quotas associated with the plurality of users,
sales volumes associated with the plurality of users,
sales attainments associated with the plurality of users,
sales modifiers associated with the plurality of users, and
sales bonuses associated with the plurality of users.

7. The method of claim 6, wherein performing the feature grouping on the updated compensation data to generate the grouped compensation data comprises grouping the compensation data based on the compensation metadata associated the plurality of users.

8. A non-transitory computer readable medium comprising computer readable program code, which when executed by a computer processor enables the computer processor to perform a method for identifying anomalies in compensation data, the method comprising:
identifying a compensation data anomaly detection event;
in response to identifying the compensation data anomaly detection event:
obtaining compensation data associated with the compensation data anomaly detection event;
performing preprocessing on the compensation data to generate updated compensation data;
performing feature grouping on the updated compensation data to generate grouped compensation data;
performing change discovery using the grouped compensation data to identify potential anomalies;
generating a comparative anomaly prediction using the potential anomalies; and
performing anomaly remediation actions based on the comparative anomaly prediction.

9. The non-transitory computer readable medium of claim 8, wherein performing preprocessing on the compensation data to generate the updated compensation data comprises:
performing standardization on the compensation data to generate standardized compensation data; and
performing transformations on the standardized compensation data to generate the updated compensation data.

10. The non-transitory computer readable medium of claim 8, wherein generating the comparative anomaly prediction using the potential anomalies comprises:
generating a first anomaly prediction using a first anomaly detection algorithm and the potential anomalies;
generating a second anomaly prediction using a second anomaly detection algorithm and the potential anomalies; and
generating the comparative anomaly prediction using the first anomaly prediction and the second anomaly prediction.

11. The non-transitory computer readable medium of claim 8, wherein the compensation data is associated with a period of time.

12. The non-transitory computer readable medium of claim 8, wherein the compensation data is associated with a plurality of users.

13. The non-transitory computer readable medium of claim 12, wherein the compensation data comprises:
compensation metadata associated with the plurality of users,
sales quotas associated with the plurality of users,
sales volumes associated with the plurality of users,
sales attainments associated with the plurality of users,
sales modifiers associated with the plurality of users, and
sales bonuses associated with the plurality of users.

14. The non-transitory computer readable medium of claim 13, wherein performing the feature grouping on the updated compensation data to generate the grouped compensation data comprises grouping the compensation data based on the compensation metadata associated the plurality of users.

15. A system for identifying anomalies in compensation data, comprising:
a plurality of clients; and
a document preprocessing engine configured to:
identify a compensation data anomaly detection event associated with compensation data of a client of the plurality of clients;
in response to identifying the compensation data anomaly detection event:
obtain compensation data associated with the compensation data anomaly detection event;
perform preprocessing on the compensation data to generate updated compensation data;
perform feature grouping on the updated compensation data to generate grouped compensation data;
perform change discovery using the grouped compensation data to identify potential anomalies;
generate a comparative anomaly prediction using the potential anomalies; and
perform anomaly remediation actions based on the comparative anomaly prediction.

16. The system of claim 15, wherein performing preprocessing on the compensation data to generate the updated compensation data comprises:
performing standardization on the compensation data to generate standardized compensation data; and
performing transformations on the standardized compensation data to generate the updated compensation data.

17. The system of claim 15, wherein generating the comparative anomaly prediction using the potential anomalies comprises:
generating a first anomaly prediction using a first anomaly detection algorithm and the potential anomalies;
generating a second anomaly prediction using a second anomaly detection algorithm and the potential anomalies; and
generating the comparative anomaly prediction using the first anomaly prediction and the second anomaly prediction.

18. The system of claim 15, wherein the compensation data is associated with a period of time.

19. The system of claim 15, wherein the compensation data is associated with a plurality of users.

20. The system of claim 19, wherein the compensation data comprises:
compensation metadata associated with the plurality of users,
sales quotas associated with the plurality of users,
sales volumes associated with the plurality of users,
sales attainments associated with the plurality of users,
sales modifiers associated with the plurality of users, and
sales bonuses associated with the plurality of users.
